(19) United States
(12) Patent Application Publication
(10) Pub. No.: US 2014/0251530 A1
(43) Pub. Date: Sep. 11, 2014

(54) APPARATUS AND PROCESS FOR THE PRODUCTION OF PAPER WEB MATERIAL

(71) Applicant: FUTURA S.P.A., Capannori (IT)

(72) Inventors: Giovacchino Giurlani, Capannori (IT); Stefano Petri, Capannori (IT)

(21) Appl. No.: 14/130,994

(22) PCT Filed: Jun. 18, 2012
(86) PCT No.: PCT/IT2012/000186

§ 371 Date: May 27, 2014

(30) Foreign Application Priority Data
Jul. 7, 2011 (IT) FI2011A000135

(51) Int. Cl. B31F 1/07

(52) U.S. Cl. CPC B31F 1/07
USPC 156/209; 156/536

(57) ABSTRACT

Apparatus for the production of a paper web, comprising: a first embossing unit (1) with a first embossing cylinder (2) and a corresponding counter-cylinder (3) for embossing a first paper ply (4); a second embossing unit (5) with a second embossing cylinder (6) and a corresponding counter-cylinder (7) for embossing a second paper ply (8), such that, once embossed, the said plies have a series of oppositely oriented reliefs (R4, R8), said embossing units (1, 5) being synchronized so that the said reliefs are nested into each other; a sizing unit (1C, 2C, 3C) associated with said first embossing cylinder (2) to distribute a predetermined amount of glue on the side of the second ply (8) opposed to that from which the respective reliefs (R8) emerge; means (11) for joining to each other the plies (4, 8) exiting from the apparatus. The apparatus comprises means (12) to form, on said second ply (8), a series of further reliefs (RC) oppositely oriented with respect to those (R8) previously formed by the second embossing unit (5), creating, on the same second ply (8), a step (S) between each further relief (RC) and the corresponding relief (R8) produced by means of the second embossing unit.

The present invention relates to an apparatus and a process for the production of paper web material.

It is known that a technique for the production of paper web material provides the embossing of two or more plies and the union of the latter by gluing.

The embossing, which produces an apparent increase in thickness of the plies, is made by passing each ply through an embossing unit which comprises an embossing cylinder, provided with reliefs and/or depressions arranged in a predetermined pattern, and a corresponding smooth counter-cylinder. The paper ply, passing between the embossing cylinder and the smooth counter-cylinder, is deformed by assuming a conformation corresponding to the reliefs, that is to the depressions, of the embossing cylinder. In other words, the ply, once embossed, exhibits a series of reliefs at regular intervals whose height, width and shape depend on the characteristics of the embossing cylinder.

The embossed plies may be arranged in various ways with respect to each other. In particular, a nested structure can be realized, with the reliefs of a ply arranged internally to the reliefs of another ply. For this purpose, the plies are embossed by means of two embossing units which are synchronized with each other.

To realize the gluing of the embossed plies, it is used a sizing unit by which the first embossed ply is adhesivised. The glue used for this purpose can be colored in order to create aesthetic effects.

The definitive union of the plies takes place by passing them, along with an eventual third ply, through a nip formed in part by the first embossing cylinder and in part by a pressure cylinder that is generally known as “marrying roll.” The adhesion takes place on the areas where the glue has been applied, that is the areas which come into contact with the layer of glue applied by the sizing unit. These areas should correspond to the contact points between the nested plies.

As schematically shown in FIG. 1 of the accompanying drawings, an inconvenience resulting from this known technique lies in that the glue (G) extends on both sides of the contact points of the nested plies (V1, V2), forming a sort of deburring that, especially when colored glue is used for aesthetic reasons, may substantially alter the appearance of the finished product. The latter, in the scheme of FIG. 1, in which is also represented a third ply (V3), is marked as a whole by the reference “P”.

An example of an apparatus and a process for the production of paper web material constituted by multiple plies which are embossed and glued together is disclosed in document GB2376436.

The main purpose of the present invention is to eliminate, or at least greatly reduce, the aforementioned drawbacks.

These results have been achieved according to the present invention by adopting the idea of realizing an apparatus and an operative process having the features indicated in the independent claims. Further features of the present invention are the subject of the dependent claims.

Thanks to the present invention, the application of the glue used to join together the plies of paper is much more precise, which allows to obtain a finished product that is more responsive to the market requirements. In addition, an apparatus and a process in accordance with the present invention do not involve a high increase in the cost of production and do not involve drastic alterations of the production cycle, which constitutes a further advantage both from the economic and technical points of view.

These and other advantages and characteristics of the present invention will be best understood by anyone skilled in the art from a reading of the following description in conjunction with the attached drawings given as a practical exemplification of the invention, but not to be considered in a limitative sense, wherein:

FIG. 1 is a schematic cross section view of a multi-plies paper web of the known type;

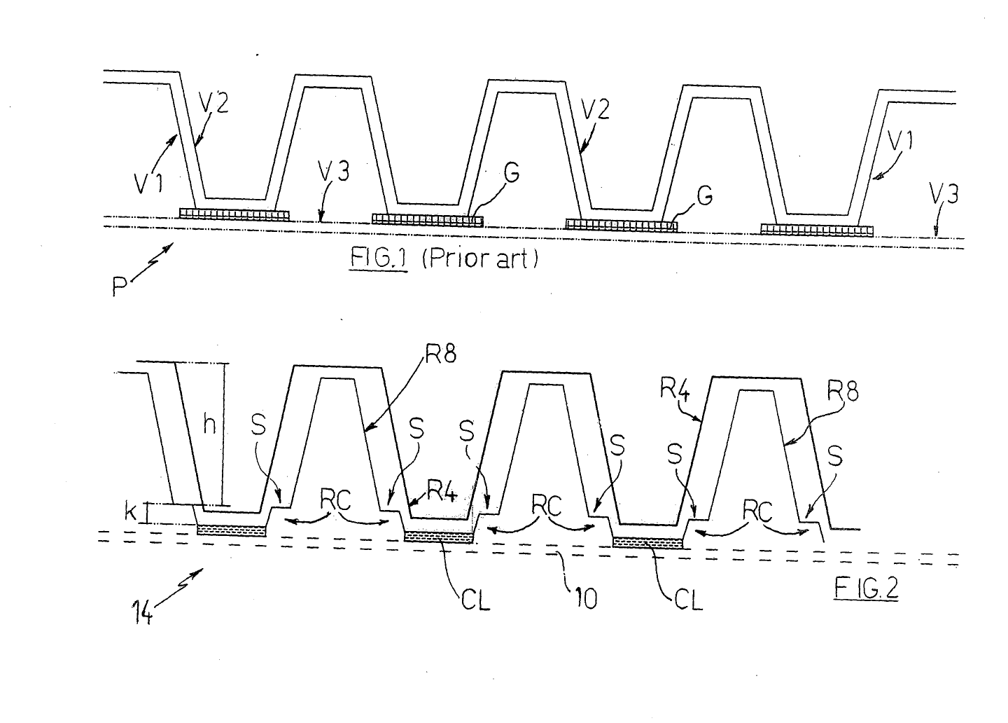

FIG. 2 shows a schematic cross section view of a multi-plies paper web according to the present invention,

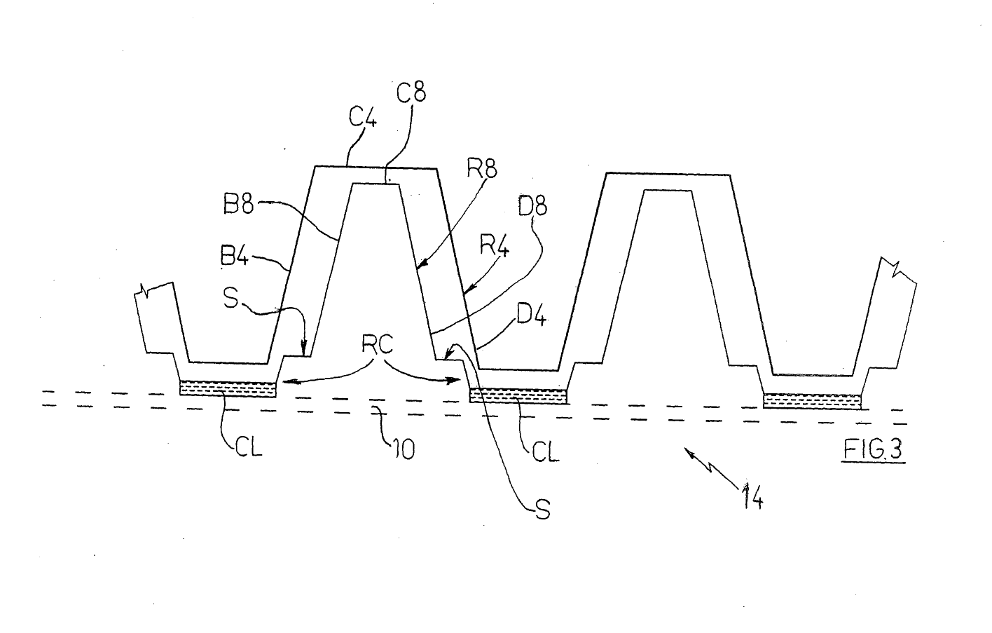

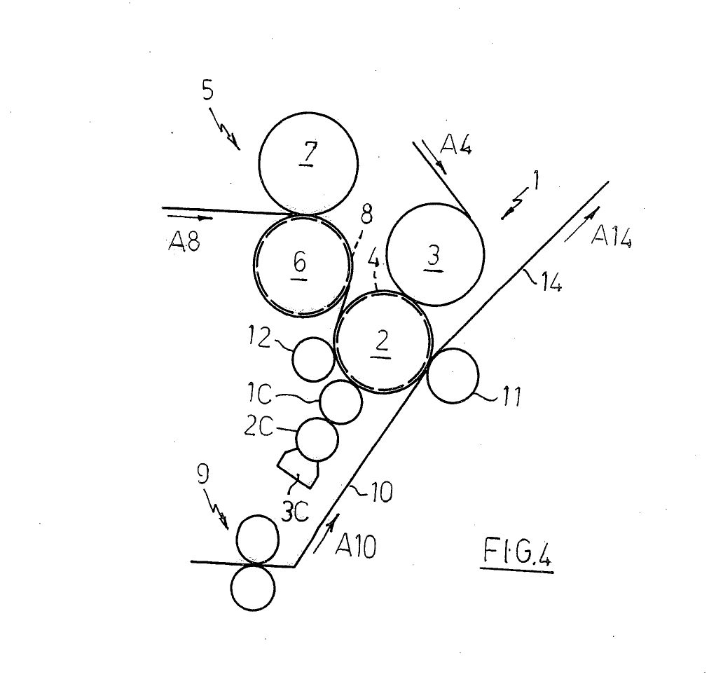

FIG. 3 is a detail of FIG. 2;

FIG. 4 schematically shows an apparatus according to the present invention.

Reduced to its essential structure and with reference to FIGS. 2 and 3 of the enclosed drawings, an apparatus according to the present invention, includes a first embossing unit (1) with a first embossing cylinder (2) and a corresponding counter-cylinder (3) by means of which the embossing of a first ply (4) is realized. The device further comprises a second embossing unit (5), with a second embossing cylinder (6) and a second counter-cylinder (7) by means of which a second ply (8) is embossed.

The embossing thus made on the plies (4) and (8) involves the formation, on each of them, of a series of depressions and corresponding reliefs (R4, R8). In other words, the embossing thus made on the said plies (4) and (8) determines the formation of a succession of corresponding reliefs (R4, R8) alternated with depressions. Each relief (R4, R8) exhibits a cross-section approximately trapezoidal shaped, with three substantially straight sides which, in the examples shown in the attached drawings, are the sides (B4, C4, D4) and (B8, C8, D8), that is, a left side (B4, B8), an upper side (C4, C8) and a right side (D4, D8).

The said embossing units (1, 5) are synchronized with each other, so that the reliefs (R8) of the second ply (8) are nested into the reliefs (R4) of the first ply (4). Still in other words, the embossing units (1, 5) carry out an embossing of the “nested” type.

The first embossing cylinder (2) is associated with a sizing unit. The latter, in the example shown in the drawings, is of the type comprising a reservoir (3C) containing liquid glue, a transfer roller (2C) and an applicator roller (1C), with the transfer roller (2C) which, being positioned between the reservoir (3C) and the applicator roller (1C) and rotating around its own longitudinal axis, picks up the glue from the reservoir (3C) and transfers it by contact on the surface of the applicator roller (1C). The latter is disposed at a predetermined distance from the first embossing cylinder (1), so that the glue present on its surface, wets the paper of the second ply (8), as further described below.

In the example shown in FIG. 3, the apparatus comprises a third embossing unit (9) in which it is realized the micro-embossing of a third ply (10). The latter can also be a smooth ply, that is not micro-embossed, or may present a third embossing synchronized with the other two.

The device further comprises a “marrying roll” (11) which is positioned close to the first embossing cylinder (1), downstream of the sizing unit (C) with respect to the direction followed by the plies (4, 8, 10).

The said embossing cylinders and related counter-cylinders, the rollers of the sizing unit and the “marrying roll” are arranged with their respective longitudinal axes parallel to each other.

The said embossing units (1, 5), the “marrying roll” (11) and the sizing unit, as well as the execution modalities of the nested embossing, are well known to the skilled in the art and, therefore, will not be described in further detail. In particular, the embossing cylinders (2) and (6) have, on their surface, a series of reliefs and depressed impressions in accordance with a predetermined embossing pattern. In accordance with the invention, a pressure rubber roller (12)—with its longitudinal axis parallel to the axis of the cylinders, counter-cylinders and rollers mentioned above—is positioned close to the first embossing cylinder (1) upstream of the sizing unit (C) with respect to the feeding direction (A4, A8) of the plies (4) and (8).

The second embossed ply (8) is coupled with the first one (4), in such a manner that the respective reliefs (R4, R8) result nested into each other, in correspondence with the first embossing cylinder (2). In practice, the plies (4, 8) previously embossed independently from each other are coupled together so as to form a nested structure, that is a structure in which each relief (R8) of the second ply (8) has each of the respective three sides (B8, C8, D8) placed internally and parallel to one of the three sides (B4, C4, D4) of a relief (R4) of the first ply (4). In other words, with reference to the figures of the attached drawings, the sides (B4, B8), (C4, C8) and (D4, D8) of the reliefs (R4, R8) are two by two substantially parallel to each other, such that the reliefs (R8) are internal to the reliefs (R4).

In particular, the roller (12) compresses both the first embossed ply (4) and the second embossed ply (8) on the surface of the first embossing cylinder (2) causing the formation of a series of further reliefs (RC) on the embossed ply (8), which further reliefs (RC) are oriented on the same direction of the reliefs

(R4) previously formed on the first ply (4), that is, oriented on the opposite direction with respect to the reliefs (R8) formed by the previous embossing of the second ply (8).

In this phase of the process, the said further reliefs

(RC) formed on the ply (8) are oriented towards the outside with respect to the first embossing cylinder (2), while the reliefs (R8) previously formed on the same ply (8) are oriented towards the first embossing cylinder (2). Furthermore, the second ply (8) results external to the first one (4). Therefore, the said further reliefs (RC) are all facing the applicator roller (1C) when the plies (4, 8) pass in correspondence of the sizing unit (C).

In the present invention, on the plies (4, 8) already nested, by means of a further embossing realized with the aid of the roller (12), further reliefs (RC) are produced on the second ply (8). In practice, by the said further embossing, on the same ply (8), a step (S) is created between each further relief (RC) and the corresponding relief (R8).

With reference to the scheme of FIG. 2, the reliefs (R8) are upwards oriented while the reliefs (RC) caused by the pressure exerted by the roller (12) and the reliefs (R4) are downwards oriented.

Likewise to the conventional embossing systems, on the outer ply (8) of the couple (4, 8) is distributed glue, but, in accordance with the present invention, the glue is distributed only in correspondence of the additional reliefs (RC) of the outer embossed ply (8). In other words, when the coupled (4, 8)—treated as described above by means of the roller (12)—passes close to the applicator roller (1C) of the sizing unit, the glue is transferred from the applicator roller (1C) to the further reliefs (RC) of the second embossed ply (8) which, as mentioned above, in this phase face the applicator roller (1C).

The result is a more precise adhesivisation, because the glue is applied only on the external side of the said further reliefs (RC), thus excluding the possibility to extend the application of glue laterally to the latter. Thanks to this, particularly when the glue is colored, drawings or decorations previously engraved or printed on the first ply (4) and/or on the second ply (8) remain unchanged or in any case conform to the desired decorative pattern. Moreover, because the sizing takes place on a less extended area, the final product is more flexible, i.e. less rigid.

As shown in FIG. 3, the definitive union of the plies (4) and (8), to whom may be added the third ply (10) eventually coming from a micro-embossing unit (13), takes place in correspondence of the nip delimited by the first embossing cylinder (1) and by the “marrying roll” (11), between which the plies pass exiting from the apparatus. In FIG. 2 and FIG. 3 the finished product, consisting of the plies (4), (8) and (10) so united and treated, is denoted by the reference number (14). In FIG. 2, the reference “CL” indicates the glue applied on the web (8). In FIG. 3 the arrows (A4, A8, A10, A14) indicate the advancing direction of the plies (4, 8, 10) and the finished product (14).

The dimensions (h) and (k) represented in FIG. 2, which respectively represent the height of the reliefs (R8) and the height of the further reliefs (RC) of the second ply (8), that is the height of the steps (S), can be for example the following: h=0.9 1.2 mm, k=0.25 0.34 mm.

As can be noted from the attached drawings, two steps (S) laterally delimit a same further relief (RC). Such pair of steps (S), in practice, projects the lower base of the depression resulting between two consecutive reliefs (R8) toward the ply (10), that is toward the roller (1C), so reducing at the same time, the surface of such base. It is accomplished, therefore, a much more precise sizing.

It is to be understood that the drawing shows only an example provided solely as a practical demonstration of the invention, and that this invention may be varied in its forms and dispositions without departure from the scope of the guiding concept of the invention. The presence of any reference numbers in the enclosed claims has the purpose of facilitating the reading of the claims with reference to the description and to the drawing, and does not limit the scope of protection represented by the claims.

1. An apparatus for the production of a paper web, comprising:
a first embossing unit with a first embossing cylinder and a corresponding counter-cylinder for embossing a first paper ply;
a second embossing unit with a second embossing cylinder and a corresponding counter-cylinder for embossing a second paper ply, such that, once embossed, said first paper ply and said second paper ply have a series of oppositely oriented reliefs, said first embossing unit and said second embossing unit being synchronized so that said oppositely oriented reliefs are nested into each other;
a sizing unit associated with said first embossing cylinder to distribute a predetermined amount of glue on a side of the second ply opposed to that from which respective reliefs emerge;
a means for joining to each other the first paper ply and the second paper ply exiting from the apparatus;
a means for forming, on said second paper ply, a series of further reliefs oppositely oriented with respect to said reliefs previously formed by the second embossing unit, creating on the second ply, a step between each further relief and a corresponding relief produced by means of the second embossing unit.

2. An apparatus according to claim 1, wherein said means for forming said series of further reliefs on the second paper ply comprises a rubber roller positioned close to the first embossing cylinder upstream of said sizing unit, said rubber roller being parallel to the first embossing cylinder.

3. An apparatus according to claim 1, wherein said means for joining the first paper ply and the second paper ply exiting from the apparatus comprises a marrying roll.

4. A process for the production of a paper web, the process comprising:
independently embossing a first ply and a second ply to form a series of oppositely oriented reliefs, on each of the first ply and the second ply and then joining the first ply and the second ply by nesting said oppositely oriented reliefs into each other and by gluing;
forming a series of further reliefs on the second embossed ply, the further reliefs being oppositely oriented with respect to said reliefs previously formed on the second ply, creating on the second ply, a step being formed between each further relief and a corresponding relief produced by means of a second embossing unit, wherein glue is distributed on said further reliefs, and the glue distributed on said further reliefs is the same glue used for gluing the first ply and the second ply.

5. A process according to claim 4, wherein said glue is colored.

6. A process according to claim 4, further comprising:
providing a first embossing unit with a first embossing cylinder and a corresponding counter-cylinder for embossing the first ply;
providing said second embossing unit with a second embossing cylinder and a corresponding counter-cylinder for embossing the second ply, such that, once embossed, said first ply and said second ply have said series of said oppositely oriented reliefs, said first embossing unit and said second embossing unit being synchronized to nest said oppositely oriented reliefs into each other;
providing a sizing unit associated with said first embossing cylinder to distribute a predetermined amount of said glue on a side of the second ply opposed to that from which respective reliefs emerge;
providing a means for joining to each other the first paper ply and the second paper ply;
providing a means for forming, on said second paper ply, said series of further reliefs, creating on the second ply, said step between said each further relief and said corresponding relief produced by means of the second embossing unit.

7. A process according to claim 4, wherein a height of said further reliefs is comprised between 0.25 and 0.34 mm.

8. A process according to claim 5, wherein a height of said further reliefs is comprised between 0.25 and 0.34 mm.

9. A process according to claim 6, wherein a height of said further reliefs is comprised between 0.25 and 0.34 mm.
